(19) United States
(12) Patent Application Publication
(10) Pub. No.: US 2022/0074234 A1
(43) Pub. Date: Mar. 10, 2022

(54) Drive Structure of Lock Bolt

(71) Applicant: Jeff Chen, Chiayi City (TW)

(72) Inventor: Jeff Chen, Chiayi City (TW)

(21) Appl. No.: 17/014,064

(22) Filed: Sep. 8, 2020

(51) Int. Cl. E05B 47/00; E05B 47/02

(52) U.S. Cl. CPC E05B 47/0012; E05B 2047/0026; E05B 2047/002; E05B 47/026

(57) ABSTRACT

A drive structure of a lock bolt contains: a lock bolt unit, a covering assembly, a motor, a gear control unit, and an electronic lock unit. The lock bolt unit includes a fixer, a linear slider, two fixing blocks, a groove defined, a driving shaft, a trench, two first through holes, a coupling plate, and a deadbolt. The covering assembly includes a first cap, a second cap, a first notch, a second notch, two locking posts, two threaded orifices, two second through orifices, a central orifice, a receiving seat, and a positioning column. The motor includes a central stem and a control circuit. The gear control unit includes a first gear, a second gear, and a belt. The first gear has a driven orifice and multiple first teeth. The second gear has a connecting orifice, multiple second teeth, a defining portion, and an actuation protrusion.

### BACKGROUND OF THE INVENTION

### Field of the Invention

The present invention relates to a drive structure of a lock bolt which is capable improving unsafety of conventional mechanical lock or electronic lock.

### Description of the Prior Art

A conventional door lock is a mechanical lock or an electronic lock which is unlocked by passwords. However, it is easy to damage the mechanical lock by using a hand tool, thus having burglary after breaking the mechanical lock and entering a house. Furthermore, the conventional mechanical lock cannot make alert after being broken, thus causing the burglary easily.

The present invention has arisen to mitigate and/or obviate the afore-described disadvantages.

### SUMMARY OF THE INVENTION

The primary object of the present invention is to provide a drive structure of a lock bolt which is capable of overcoming the shortcomings of the conventional drive structure. For example, it is easy to damage the mechanical lock by using a hand tool, thus having burglary after breaking the mechanical lock and entering a house. Furthermore, the conventional mechanical lock cannot make alert after being broken, thus causing the burglary easily.

To provide above-mentioned objects, a drive structure of a lock bolt provided by the present invention contains: a lock bolt unit, a covering assembly, a motor, a gear control unit, and an electronic lock unit.

Thereby, a Bluetooth receiver unit of the electronic lock unit mates with the Bluetooth functions of a mobile device simultaneously so that a user inputs passwords and security codes to compare the passwords with the security codes. When the passwords match with the security codes, the electronic lock unit sends an unlocking signal to the motor, the gear control unit is actuated by the motor to rotate in the clockwise direction, and the actuation protrusion of a second gear drives a linear slider and a deadbolt to unlock. When the passwords do not match with the security codes, the electronic lock unit is locked still.

### BRIEF DESCRIPTION OF THE DRAWINGS

FIG. 1 is a perspective view showing the assembly of a drive structure of a lock bolt according to a preferred embodiment of the present invention.

FIG. 2 is a perspective view showing the exploded components of the drive structure of the lock bolt according to the preferred embodiment of the present invention.

FIG. 3 is a perspective view showing the assembly of a gear control unit of the drive structure of the lock bolt according to the preferred embodiment of the present invention.

FIG. 4 is a cross sectional view showing the assembly of the drive structure of the lock bolt according to the preferred embodiment of the present invention.

FIG. 5 is a cross sectional perspective view showing the application of the drive structure of the lock bolt according to the preferred embodiment of the present invention.

FIG. 6 is a cross sectional perspective view showing the assembly of a door panel according to the preferred embodiment of the present invention.

FIG. 7 is a side plan view showing the operation of the drive structure of the lock bolt according to the preferred embodiment of the present invention.

FIG. 8 is another side plan view showing the operation of the drive structure of the lock bolt according to the preferred embodiment of the present invention.

FIG. 9 is a block diagram of the drive structure of the lock bolt according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

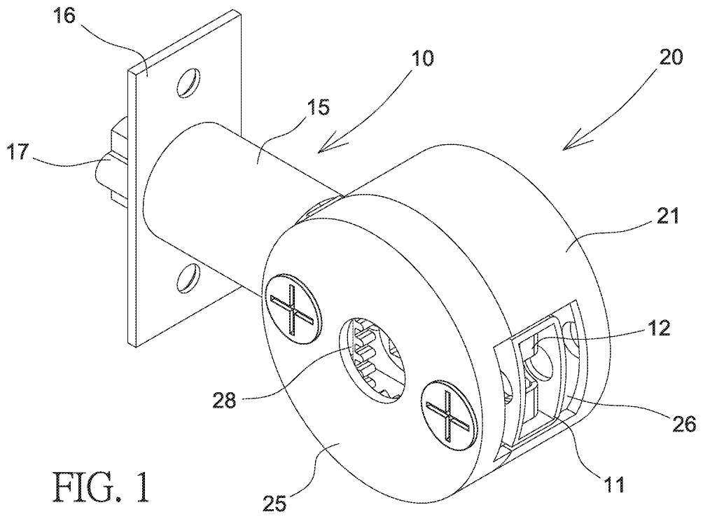

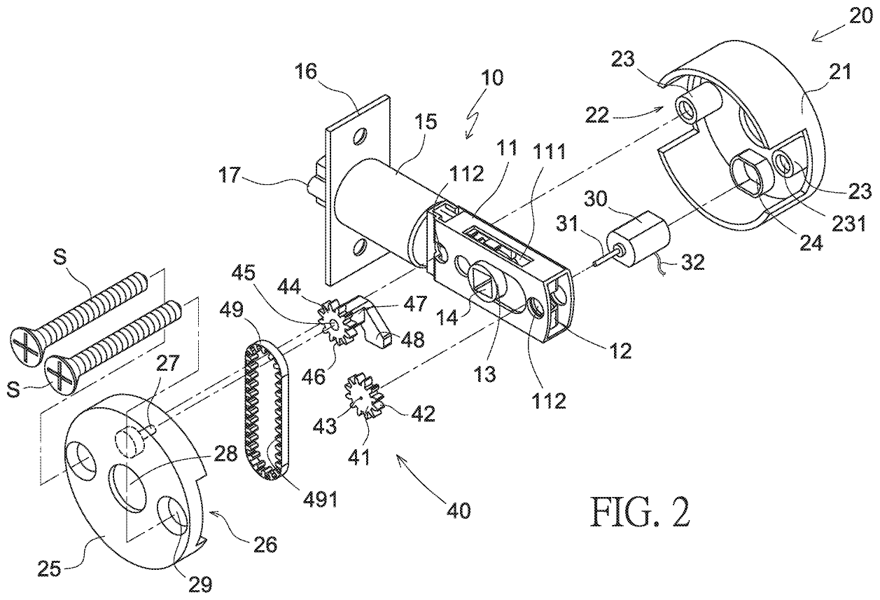

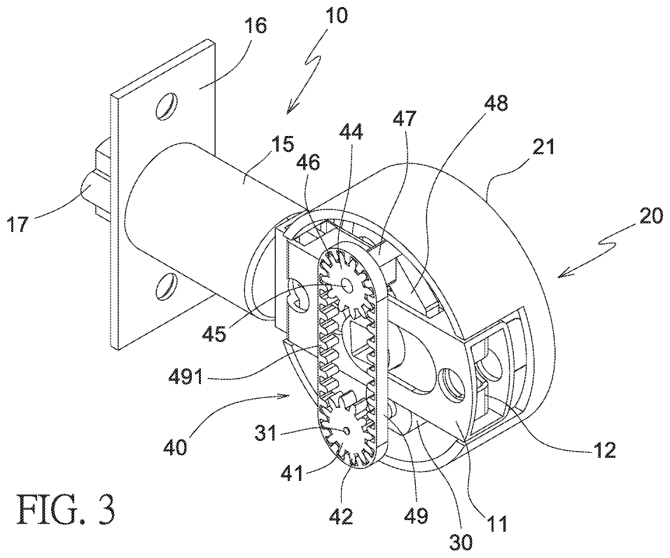

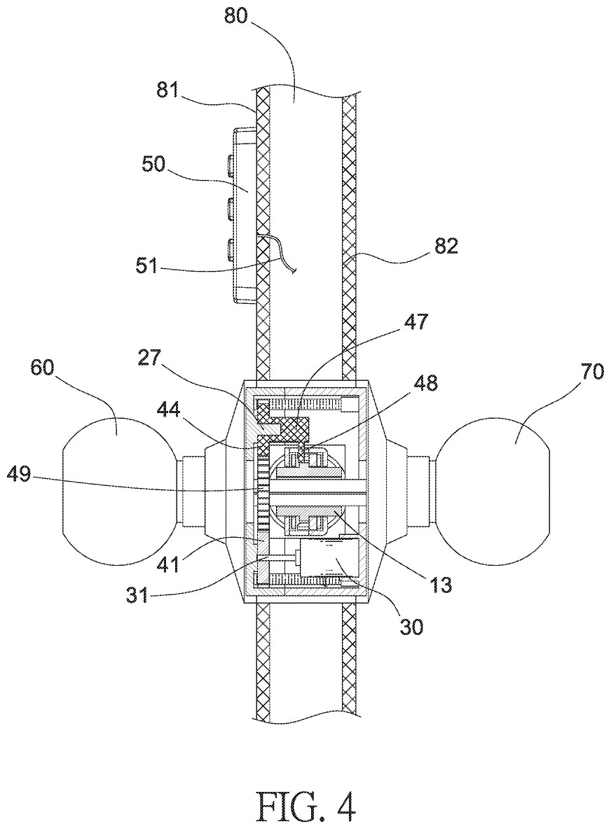

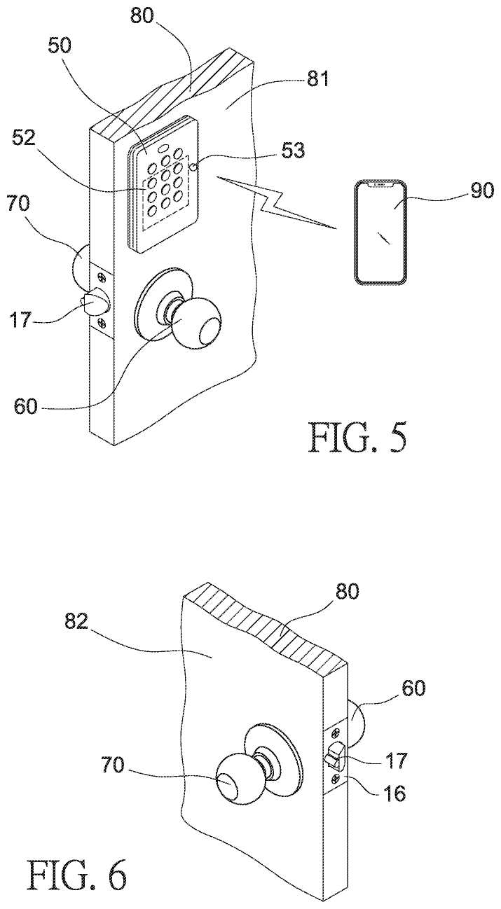

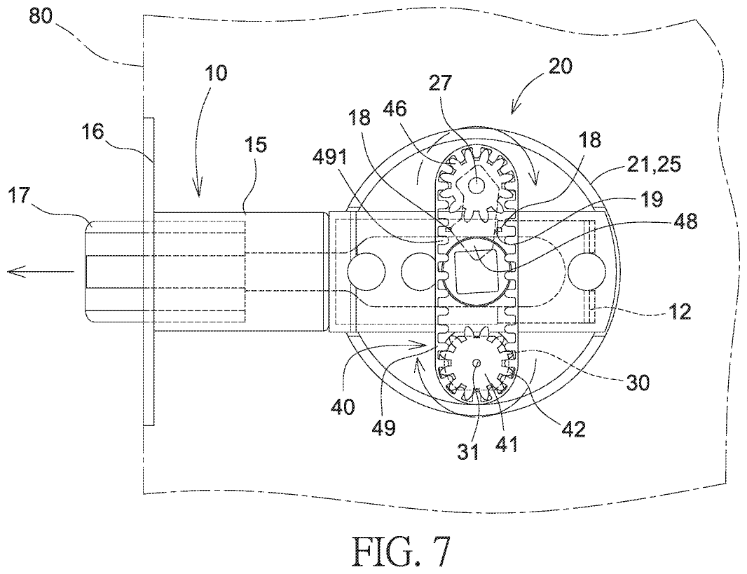

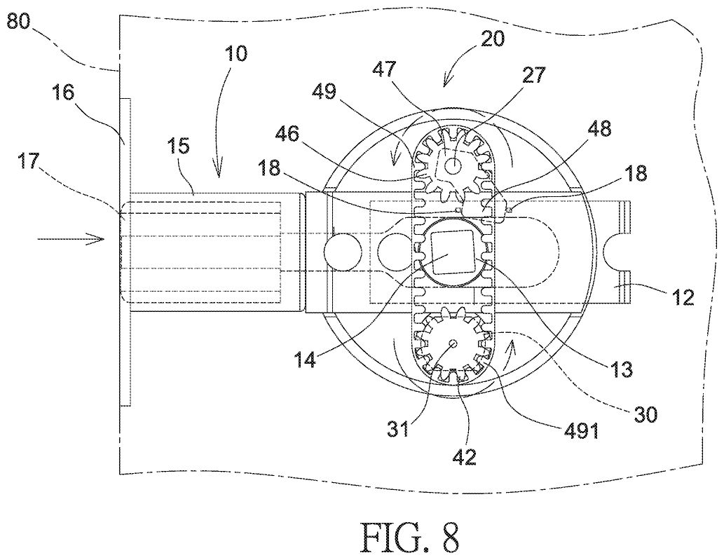

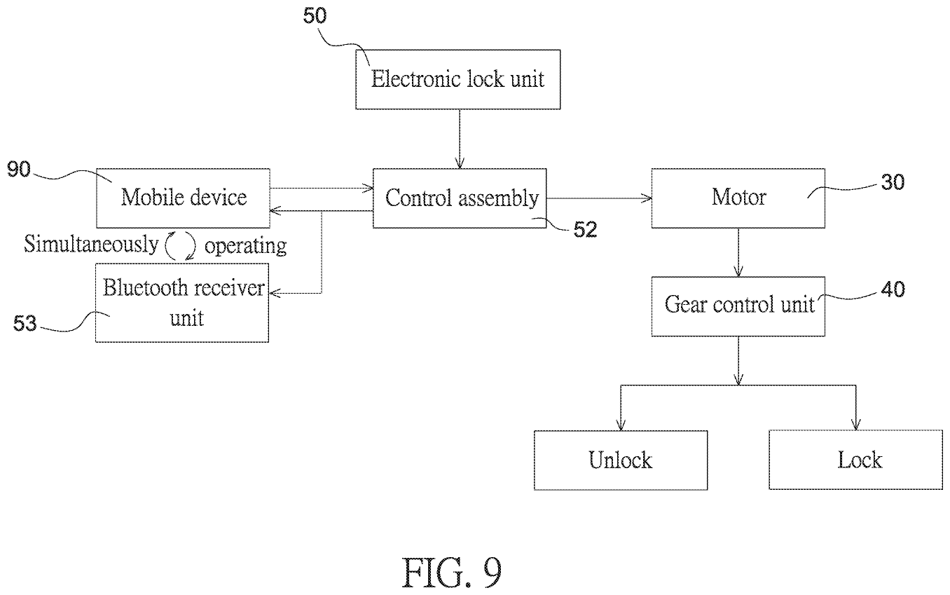

With reference to FIGS. 1-9, a drive structure of a lock bolt according to a preferred embodiment of the present invention comprises:

a lock bolt unit 10 including a fixer 11, a linear slider 12 received in the fixer 11, two fixing blocks 18 mounted in the linear slider 12, a groove 19 defined between the two fixing blocks 18, a guide slot 111 formed on a top of the fixer 11 and corresponding to the two fixing block 18, a driving shaft 13 arranged on a predetermined position of the fixer 11, a trench 14 defined on a center of the driving shaft 13 which corresponds to the linear slider 12, two first through holes 112 formed on two sides of the fixer 11, a connection seat 15 connected with an end of the fixer 11, a coupling plate 16 coupled on a side of the connection seat 15, and a deadbolt 17 fixed on the coupling plate 16 with respective to the linear slider 12;

a covering assembly 20 including a first cap 21 and a second cap 25 which are configured to cover the fixer 11 of the lock bolt unit 10, a first notch 22 and a second notch 26 which are formed on two sides of the covering assembly 20 and are configured to extend the fixer 11 out of the lock bolt unit 10, two locking posts 23 extending from the first cap 21 and corresponding to the fixer 11, two threaded orifices 231 formed on inner walls of the two locking posts 23, two second through orifices 29 defined on the second cap 25 and corresponding to the two first through holes 112 of the fixer 11 so that two screw bolts S are inserted through the second through orifices 29, the first through holes 112, and the two threaded orifice 231 to connect the covering assembly 20 and the lock bolt unit 10, the covering assembly 20 further including a central orifice 28 corresponding to the driving shaft 13 of the lock bolt unit 10, a receiving seat 24 formed on a predetermined position of an inner wall of the first cap 21, and a positioning column 27 extending from a predetermined position of an inner wall of the second cap 25;

a motor 30 accommodated in the receiving seat 24 of the first cap 21, the motor 30 including a central stem 31 extending from an end of the motor 30, and the motor 30 also including a control circuit 32 arranged in the motor 30;

a gear control unit 40 including a first gear 41, a second gear 44, and a belt 49, wherein the first gear 41 has a driven orifice 43 defined in a center thereof and rotatably connected with the central stem 31 of the motor 30, multiple first teeth 42 formed around a peripheral side of the first gear 41, and the second gear 44 has a connecting orifice 45 defined on a center thereof and rotatably connected with the positioning column 27 of the second cap 25, multiple second teeth 46 formed around a peripheral side of the second gear 44, a defining portion 47 formed on an end of the second gear 44, and an actuation protrusion 48 extending from s side of the defining portion 47, the belt 49 has multiple driving teeth 491 formed on an inner rim thereof so as to mesh with the multiple first teeth 42 and the multiple second teeth 46 after the inner rim of the belt 29 is fitted with the first gear 41 and the second gear 44, hence when the motor 30 rotates in a clockwise direction or a counterclockwise direction, the first gear 41 is driven by the motor 30 to actuate the belt 49 and the second gear 44 to rotate; and

an electronic lock unit 50 including a control assembly 52 which has a signal circuit 51 electrically connected with the control circuit 32 of the motor 30 to control the motor 30 to rotate in the clockwise direction or the counterclockwise direction with respective to the gear control unit 40, such that the second gear 44 is driven by the actuation protrusion 48 to control the linear slider 12 and the deadbolt 17 to move forward or backward; the control unit 52 further having a Bluetooth receiver unit 53 accommodated therein to mate with a predetermined Bluetooth functions of a mobile device 90.

The drive structure of the lock bolt is disposed on a door panel 80 having an internal face 82 and an external face 81 so that the first cap 21 and the second cap 25 of the covering assembly 20 expose outside the internal face 82 and the external face 81 of the door panel 80, and the covering assembly 20 includes a first horn lock 60 corresponding to the central orifice 28 of the first cap 21, and the covering assembly 20 includes a second horn lock 70 corresponding to the central orifice 28 of the second cap 25, wherein the electronic lock unit 50 is mounted on the external face 81 of the door panel 80 and is located beside the first horn lock 60.

Thereby, the Bluetooth receiver unit 53 of the electronic lock unit 50 mates with the Bluetooth functions of the mobile device 90 simultaneously so that a user inputs passwords and security codes to compare the passwords with the security codes. When the passwords match with the security codes, the electronic lock unit 50 sends an unlocking signal to the motor 30, the gear control unit 40 is actuated by the motor 30 to rotate in the clockwise direction, and the actuation protrusion 48 of the second gear 44 drives the linear slider 12 and the deadbolt 17 to unlock. When the passwords do not match with the security codes, the electronic lock unit 50 is locked still.

While various embodiments in accordance with the present invention have been shown and described, it is clear to those skilled in the art that further embodiments may be made without departing from the scope of the present invention.

What is claimed is:

1. A drive structure of a lock bolt comprising:
a lock bolt unit including a fixer, a linear slider received in the fixer, two fixing blocks mounted in the linear slider, a groove defined between the two fixing blocks, a guide slot formed on a top of the fixer and corresponding to the two fixing block, a driving shaft arranged on a predetermined position of the fixer, a trench defined on a center of the driving shaft which corresponds to the linear slider, two first through holes formed on two sides of the fixer, a connection seat connected with an end of the fixer, a coupling plate coupled on a side of the connection seat, and a deadbolt fixed on the coupling plate with respective to the linear slider;
a covering assembly including a first cap and a second cap which are configured to cover the fixer of the lock bolt unit, a first notch and a second notch which are formed on two sides of the covering assembly and are configured to extend the fixer out of the lock bolt unit, two locking posts extending from the first cap and corresponding to the fixer, two threaded orifices formed on inner walls of the two locking posts, two second through orifices defined on the second cap and corresponding to the two first through holes of the fixer so that two screw bolts are inserted through the second through orifices, the first through holes, and the two threaded orifice to connect the covering assembly and the lock bolt unit, the covering assembly further including a central orifice corresponding to the driving shaft of the lock bolt unit, a receiving seat formed on a predetermined position of an inner wall of the first cap, and a positioning column extending from a predetermined position of an inner wall of the second cap;
a motor accommodated in the receiving seat of the first cap, the motor including a central stem extending from an end of the motor, and the motor also including a control circuit arranged in the motor;
a gear control unit including a first gear, a second gear, and a belt, wherein the first gear has a driven orifice defined in a center thereof and rotatably connected with the central stem of the motor, multiple first teeth formed around a peripheral side of the first gear, and the second gear has a connecting orifice defined on a center thereof and rotatably connected with the positioning column of the second cap, multiple second teeth formed around a peripheral side of the second gear, a defining portion formed on an end of the second gear, and an actuation protrusion extending from s side of the defining portion, wherein the belt has multiple driving teeth formed on an inner rim thereof so as to mesh with the multiple first teeth and the multiple second teeth after the inner rim of the belt is fitted with the first gear and the second gear, hence when the motor rotates in a clockwise direction or a counterclockwise direction, the first gear is driven by the motor to actuate the belt and the second gear to rotate; and
an electronic lock unit including a control assembly which has a signal circuit electrically connected with the control circuit of the motor to control the motor to rotate in the clockwise direction or the counterclockwise direction with respect to the gear control unit, such that the second gear is driven by the actuation protrusion to control the linear slider and the deadbolt to move forward or backward; the control unit further having a Bluetooth receiver unit accommodated therein to mate with a predetermined Bluetooth functions of a mobile device.

2. The drive structure as claimed in claim 1, wherein the drive structure is disposed on a door panel having an internal face and an external face so that the first cap and the second cap of the covering assembly expose outside the internal face and the external face of the door panel, and the covering assembly includes a first horn lock corresponding to the central orifice of the first cap, and the covering assembly includes a second horn lock corresponding to the central orifice of the second cap, wherein the electronic lock unit is mounted on the external face of the door panel and is located beside the first horn lock.
